(19) United States
(12) Patent Application Publication
(10) Pub. No.: US 2025/0365349 A1
(43) Pub. Date: Nov. 27, 2025

(54) ENTRY MANAGEMENT METHOD AND SERVER OF SERVICE SERVER BASED ON DIGITAL SERVICE

(71) Applicant: STCLab. Co., Ltd., Seoul (KR)

(72) Inventors: Hoon Ho JUNG, Bucheon-si (KR); Hyung Joon Park, Seoul (KR)

(73) Assignee: STCLab. Co., Ltd., Seoul (KR)

(21) Appl. No.: 19/254,772

(22) Filed: Jun. 30, 2025

Related U.S. Application Data
(63) Continuation of application No. PCT/KR2023/021775, filed on Dec. 27, 2023.

(30) Foreign Application Priority Data
Dec. 30, 2022 (KR) 10-2022-0190163

(51) Int. Cl. H04L 67/60; H04L 43/0876; H04L 47/50

(52) U.S. Cl. CPC H04L 67/60; H04L 43/0876; H04L 47/50

(57) ABSTRACT

The present disclosure relates to an entry management method and server of a service server based on a digital service, which automatically adjusts an entry allowance number to a service server providing a content service according to a situation, thereby preventing unnecessary resource waste of the service server in advance, maintaining a stable connection to the service server, and improving the satisfaction of both the service server and the user by applying an appropriate entry allowance number by verifying and determining the entry allowance number of the service server in various ways.

### CROSS-REFERENCE TO RELATED APPLICATIONS

The present application is a Continuation of International Application No. PCT/KR2023/021775 filed on Dec. 27, 2023, which is based upon and claims the benefit of priority to Korean Patent Application No. 10-2022-0190163 filed on Dec. 30, 2022 in the Korean Intellectual Property Office, the entire contents of which are incorporated herein by reference.

### TECHNICAL FIELD

The present disclosure relates to a method of managing entry into a service server. More specifically, the present disclosure relates to an entry management method and server of a service server based on a digital service.

### BACKGROUND ART

As the number of simultaneous users of a service server providing content services such as course registration, concert reservation, and purchase events increases, the response speed of the service server providing the content services is often reduced or the service is interrupted.

The system may include a WEB providing a page composed of HTML (hypertext markup language), a WAS (web application server) processing an application service for a request message transmitted from the WEB, and a database storing data that can be provided as a response to a query statement.

In the above-described system, when there is a surge in concurrent users, the response time of the WEB may be delayed due to insufficient network bandwidth.

### DETAILED DESCRIPTION OF THE INVENTION

### Technical Problem

The present disclosure is to provide an entry management method and server of a service server based on a digital service for efficiently controlling entry into a service server providing a content service.

The problems to be solved by the present disclosure are not limited to the problems mentioned above, and other problems not mentioned will be clearly understood by those skilled in the art from the description below.

### Technical Solution

In an aspect of the present disclosure, an entry management server of a service server based on a digital service may include a TS processing module; an IC processing module; and a processor, wherein the processor is configured to: collect status information through the TS processing module and receive a load test result for the service server, set an entry allowance number to the service server based on the status information and the load test result through the IC processing module, and control an entry of a user terminal to the service server based on the entry allowance number, before controlling the entry to the service server, based on history of a same event of the service server being not present when the entry allowance number is verified and then readjusted, the entry allowance number is used as an initial case and trained with a first AI model, based on history being present, determine whether the entry allowance number is required to be adjusted through a second AI model trained with the history, wherein the history includes past measurement data of the service server, a past entry allowance number, and a past occurrence event, and when controlling the entry to the service server, retrieve an issued key as soon as the entry to the service server is completed through the TS processing module by the user in a queue, and issue the key to another user in the queue.

Furthermore, in another aspect of the present disclosure, an entry management method of a service server based on a digital service performed by an entry management server may include collecting status information and receiving a load test result for the service server; setting an entry allowance number to the service server based on the status information and the load test result; and controlling an entry of a user terminal to the service server based on the entry allowance number, wherein the entry management server is configured to: before controlling the entry to the service server, based on history of a same event of the service server being not present when the entry allowance number is verified and then readjusted, the entry allowance number is used as an initial case and trained with a first AI model, based on history being present, determine whether the entry allowance number is required to be adjusted through a second AI model trained with the history, wherein the history includes past measurement data of the service server, a past entry allowance number, and a past occurrence event, and when controlling the entry to the service server, retrieve an issued key as soon as the entry to the service server is completed through the TS processing module by the user in a queue, and issue the key to another user in the queue.

In addition, a computer program stored in a computer-readable recording medium for executing a method for implementing the present disclosure may be further provided.

In addition, a computer-readable recording medium recording a computer program for executing a method for implementing the present disclosure may be further provided.

### Advantageous Effects of the Invention

According to the present disclosure, since the entry allowance number to a service server providing a content service is automatically adjusted according to the situation, unnecessary resource waste of the service server can be prevented in advance, and the connection to the service server can be maintained in a stable state.

According to the present disclosure, since the entry allowance number of the service server is determined by verifying it in various ways, the satisfaction of both the service server and the user can be improved by applying an appropriate entry allowance number.

The effects of the present disclosure are not limited to the effects mentioned above, and other effects not mentioned will be clearly understood by those skilled in the art from the description below.

### DESCRIPTION OF THE DRAWINGS

FIG. 1 is a diagram illustrating an overall system for describing an entry management method to a service server of the present disclosure.

FIG. 2 is a block diagram illustrating a configuration of an entry management server of the present disclosure.

FIG. 3 is a flowchart for describing an entry management method of the present disclosure.

FIG. 4 is a flowchart for describing a part of FIG. 3 in detail.

FIG. 5 is an exemplary diagram for describing an entry management method of the present disclosure.

### BEST MODE

The same reference numerals refer to the same elements throughout the present disclosure. This disclosure does not describe all elements of the embodiments, and any content that is general in the technical field to which this disclosure belongs or that overlaps between embodiments is omitted. The terms ‘part, module, element, block’ used in the specification can be implemented in software or hardware, and according to the embodiments, a plurality of ‘parts, modules, elements, blocks’ can be implemented as a single element, or a single ‘part, module, element, block’ can include a plurality of elements.

Throughout the specification, when a part is said to be “connected” to another part, this includes not only the case where it is directly connected, but also the case where it is indirectly connected, and the indirect connection includes the connection via a wireless communication network.

Also, when a part is said to “include” a component, this does not mean that other components are excluded, unless otherwise specifically stated, but that other components may be included.

Throughout the specification, when a component is said to be “on” another component, this includes not only the case where the component is in contact with the other component, but also the case where another component exists between the two components.

The terms first, second, and the like are used to distinguish one component from another component, and the components are not limited by the aforementioned terms.

A singular expression includes a plural expression unless there is an obvious exception in the description.

The identifiers in each step are used for convenience of description and do not describe the order of each step, and each step may be performed in a different order than the stated order unless the description clearly describes a specific order.

The operating principle and embodiments of the present disclosure are described with reference to the attached drawings.

In this specification, the ‘entry management server according to the present disclosure’ includes various devices that can perform computational processing and provide results to a user. For example, the entry management server according to the present disclosure may include a computer, a server device, and a portable terminal, or may be in the form of one of them.

Here, the computer may include, for example, a notebook, desktop, laptop, tablet PC, slate PC, etc. equipped with a web browser.

The server device is a server that communicates with an external device to process information, and may include an application server, a computing server, a database server, a file server, a game server, a mail server, a proxy server, and a web server.

The portable terminal may include, for example, a wireless communication device that ensures portability and mobility, such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a WiBro (Wireless Broadband Internet) terminal, a smart phone, and all kinds of handheld-based wireless communication devices, as well as wearable devices such as watches, rings, bracelets, anklets, necklaces, glasses, contact lenses, or head-mounted devices (HMDs).

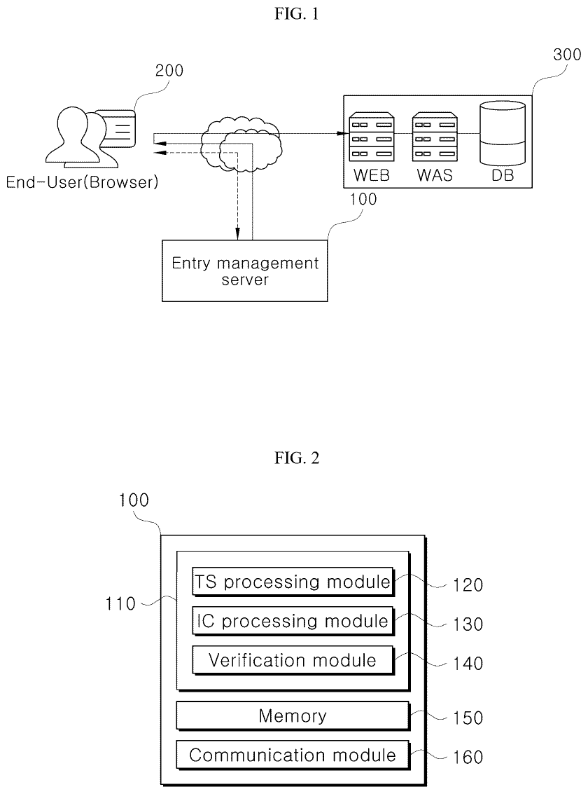

FIG. 1 is a diagram illustrating an overall system for describing an entry management method to a service server of the present disclosure.

Referring to FIG. 1, an entry management server 100 is located between a user terminal (End-User (Browser)) 200 and a service server 300, and may manage the entry of the user terminal 200 to the service server 300.

The entry management server 100 may perform procedures for blocking, bypassing, and entry allowance management for the user terminal 200 requesting access to the service server 300.

The blocking may mean a procedure for transmitting blocking information to the user terminal 200 to prevent the selection of a button (e.g., submit and confirm, etc.) that causes a specific action when the number of accesses per second is at a macro second level.

The bypass may mean a procedure for bypassing a queue for entry into the service server 300 to enter directly into the service server 300 without waiting in case of a specific policy or major client.

The entry allowance management means a normal queue management for entry into the service server 300, and may mean a procedure for managing resources or status of the service server 200 that provides a content service by controlling entry based on an entry allowance number.

In this case, the entry allowance number may mean the number of users who may simultaneously enter a specific transaction (e.g., login button, course registration button, etc.) of the service server 300 at a given time by receiving a key from the entry management server 100. At this time, the number of users may mean the number of user terminals 200 that may actually enter the service server 300 through the user terminal 200.

For example, in the case that the entry allowance number for the service server 300 providing a course registration service is 50, and 55 people select the course registration button at the same time, the entry management server 100 may allow simultaneous entry into the service server 300 for 50 people, but may process 5 people so that they may be placed in a waiting line. Afterwards, when the entry into the service server 300 for 50 people is completed and an issued key is retrieved, the retrieved key is reissued to the 5 people placed in the waiting line so that they may enter sequentially.

For this purpose, it may be important for the entry management server 100 to set the entry allowance number appropriately. In the case that the entry allowance number is set higher than the appropriate number, many waiting users may enter the service server at the same time, but the service server 300 becomes unstable, and in the case that the entry allowance number is set lower than the appropriate number, a small number of waiting users may enter the service server 300 stably, but there may be a problem of wasting the resources of the service server 300. Accordingly, the entry management server 100 of the present disclosure may appropriately set the entry allowance number based on status information. A detailed description of this will be described later.

The service server 300 may include a web server, a web application server (hereinafter referred to as a WAS), and a database (DB). In this case, the database may also be called a database management system (DBMS).

The web server refers to a server that mainly processes requests from clients such as a web browser or a web crawler based on the HTTP (hypertext transfer protocol), and may reply with an HTTP response when receiving an HTTP request.

For example, the web server may receive a file path name and return static file content (html, jpeg, css, etc.) that matches the path.

The web server may transmit a request for providing dynamic content to the WAS, and receive a processing result from the WAS and transmit the result to a client.

The WAS refers to an application server using HTTP, and may include a container that enables the web server specialized in processing static HTTP data to use dynamic data.

The WAS may be an application server for providing dynamic content that requires database querying or various logic processing. The WAS may be a middleware software engine that executes an application on a computer or device via HTTP. The WAS may also be called a web container or a servlet container. In this case, the container may mean software that may execute JSP and Servlet.

The WAS may be applied in a distributed environment that processes functions such as distributed transactions, security, messaging, and thread processing.

Specifically, the WAS may implement a program execution environment and a database connection function and a number of transaction management functions. The transaction may mean a logical work unit.

The WAS may receive the data from the database according to the user's request, and generate and provide the result in real time according to the business logic. The WAS may be implemented in multiple modules, and the number of WAS applied to each service server 300 may be different.

The database may mean a component that stores and manages data. At this time, the database may reply the corresponding data according to the request of the WAS.

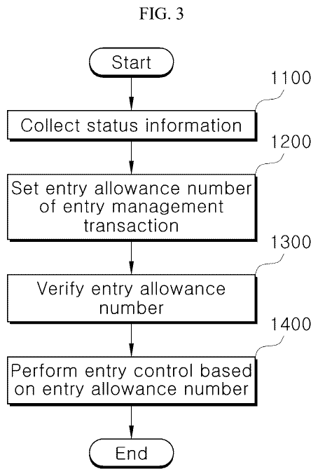

FIG. 2 is a block diagram illustrating a configuration of an entry management server of the present disclosure.

Referring to FIG. 2, the entry management server 100 includes a processor 110, a memory 150, and a communication module 160. In this case, the processor 110 may control the operation of each of the corresponding components, including a TS processing module 120, an IC processing module 130, and a verification module 140. The components illustrated in FIG. 2 are not essential for implementing the entry management server 100 according to the present disclosure, and thus, the entry management server 100 described in this specification may have more or fewer components than the components listed above.

The processor 110 may limit the entry request for each transaction unit (e.g., each unit such as login, inquiry, and course registration through the user terminal 200) and may control the entry by limiting the number of logins per second.

The processor 110 may collect status information. The status information is information to be considered for adjusting or maintaining the entry allowance number of the user terminal 200 to the service server 300, and may be service status information or service server information collected from the service server 300.

The processor 110 may set the entry allowance number to the service server based on the status information, but may set an initial entry allowance number or change the preset entry allowance number.

The processor 110 may control the entry of the user terminal 200 to the service server 300 based on the set entry allowance number.

Referring to FIG. 2, the processor 110 may manage a key to be issued when the user terminal 200 enters through the TS (transaction) processing module 120. Specifically, the processor 110 may perform key issuance and key recovery functions through the TS processing module 120. At this time, the entry of the user terminal 200 API may be permitted according to the key issuance through the TS processing module 120 of the processor 110.

The processor 110 may collect and monitor in real time the service status information in the transaction linked to the entry management function through the TS processing module 120. The entry management function may mean controlling the entry of the user terminal 200 to the service server 300 according to the entry allowance number.

At this time, the fact that the entry management function is linked may mean that a source code for entry management is applied to a specific button and page where entry management is required. For example, the entry management function may be linked to selectively control each button on a specific page, such as the course registration, draw, and reservation buttons, or may be linked to a single page.

The service status information may include at least one of the processing speed including the user's perceived speed and response speed, the service request volume, the number of people waiting, the waiting time, the system entry volume, the resource usage, or the processing time. In this case, the processing speed and the processing time may mean the user's perceived speed and the perceived time when the corresponding page is output through the user terminal 200 according to the selection of a specific transaction (button or page) through the user terminal 200. The service request volume may mean the entry request volume of the user terminal 200 for each specific transaction. The number of people waiting and the waiting time may mean the number of people waiting in the queue for each specific transaction of the entry management server 100 and the waiting time for each person waiting, respectively. In addition, the system entry volume may mean the entry volume of users who entered the service server 300 from the transaction-specific queue. In addition, the resource usage may mean the resource usage in the entry management server 100.

For example, when the course registration button is selected through the user terminal 200, the processor 110 may collect the time data (processing time described above) required for the course registration page to be logged through the TS processing module 120.

As the login button is selected through the user terminal 200, the entry management server 100 may receive a key issuance and an entry request.

When entry to the service server 300 is available, the processor 110 may perform the key issuance through the TS processing module 120. In the case that the entry to the service server 300 is not available, the processor 110 may call up a queue arrangement and a waiting screen for the user terminal 200 through the TS processing module 120.

At this time, the processor 110 may receive the entry request from the user terminal 200 regardless of whether the user enters the service server 300 through the TS processing module 120, and transmit the entry request to the WAS of the service server 300 so that the entry request may be recorded.

The processor 110 may retrieve the key when the user terminal 200 that has been issued a key completes entering the service server 300.

The processor 110 may collect the time from the time of issuing the key (entry time) to the user terminal 200 to the time of key retrieval time (entry completion time) through the TS processing module 120 as the processing time and store the time in the memory 150. In this case, the processing time may be the user perceived time. The entry completion time may be the same as the time when the corresponding page is output on the user terminal 200 described above.

For example, the processing time may mean the time when the login button is selected on the user terminal 200, the entry request is transmitted to the WAS, and the result page is loaded on the web screen of the user terminal 200.

Meanwhile, the more users requesting entry to the service server 300, the slower the response, so the processing time may also increase. The entry management server 100 may not be used continuously by users who have entered, but may be managed in a transaction unit. In other words, when entering for each button, such as login, inquiry, and the like, the entry management server 100 may be asked whether to enter before entering.

In the case that the entry management is applied to each page, the processor 100 may limit the number of clicks per second. For example, in the case that the number of clicks allowed per second is 100, the processor 100 may process simultaneous logins for 100 user terminals 200.

The processor 110 may receive data collected by the TS processing module 120 through the IC (intelligent control) processing module 130 and control the user entry allowance number using the service server information. In this case, the service server information may include APM (Application Performance Management) data.

The APM may be collected as service server information indicating the status of the service server by monitoring the WAS (Web application Server) of the service server 300.

The IC processing module 130 may gather the service server information through the open API of the service server 300. In this case, the service server information refers to the information of the service server 300 that is required to be considered to control the entry allowance number, and may include at least one of CPU information, memory information, disk information, network information, processing capacity, a number of threads, a response time, concurrent terminal users, an active service, an active user, an error rate, a rejection rate, a number of hits per hour, a number of visitors per hour, a number of hits per day, a number of visitors per day, a customer WAS status, JDBC (java database connectivity) idle, JDBC allocation, JDBC activity, total JVM (java virtual machine) memory, or JVM memory usage. In other words, the service server information may include backend data indicating the status of the service server that may be collected from the customer's service server 300.

The processor 110 may set an appropriate entry allowance number for a transaction to which entry management is applied based on the service status information collected by the TS processing module 120 and the collected service server information (e.g., APM data) transmitted through the IC processing module 130.

The processor 110 may perform an entry management control operation by generating a command to increase or decrease the entry allowance number according to a preset rule through the IC processing module 130. For example, the preset rule may include a rule such as lowering the entry allowance number from 100 to 50 when the processing speed is lower than the preset threshold, thereby lowering the load on the service server 300 and recovering the processing speed.

The TS processing module 120 and IC processing module 130 described above may be implemented together in one component as shown in FIG. 1, but are not limited thereto, and may also be implemented as separate servers from the entry management server 100. In this case, the TS processing module 120 and IC processing module 130 may transmit and receive data to each other through the entry management server 100.

The processor 110 may perform verification on the entry allowance number set through the verification module 140, and may change or maintain the entry allowance number according to the verification result.

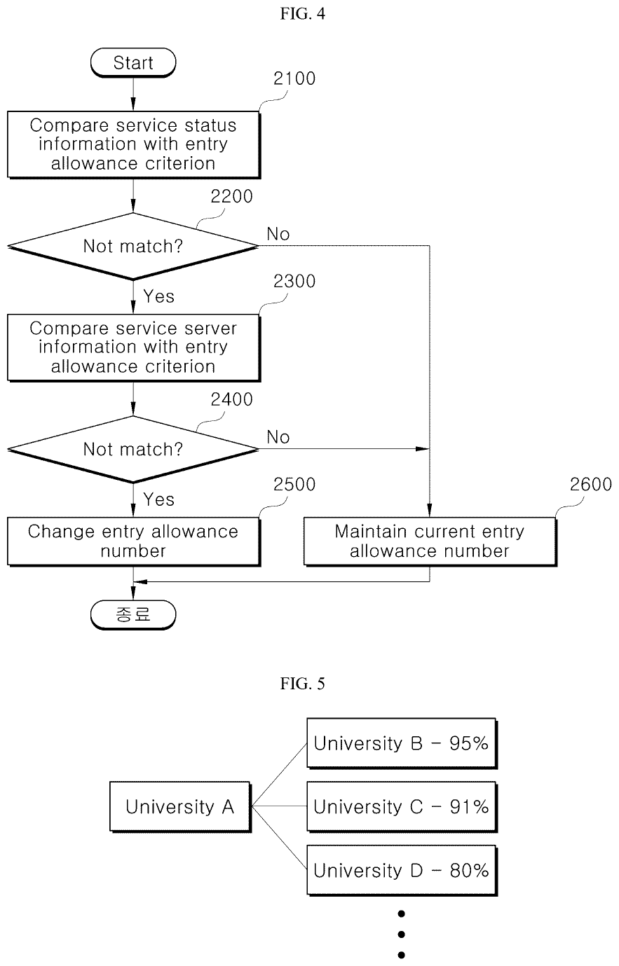

The processor 110 described above will be described in detail through the description of FIG. 3 and FIG. 4 described below.

The memory 150 may store a computer program for providing an entry management method of a service server based on a digital service, and the stored computer program may be read and operated by the processor 110. The memory 150 may store any form of information generated or determined by the processor 110 and any form of information received by the communication module 160.

The memory 150 may store data supporting various functions of the entry management server 100, a program for the operation of the processor 110, may store input/output data, and may store a plurality of application programs (or applications) operated by the entry management server 100, data for the operation of the entry management server 100, and commands. At least some of these application programs may be downloaded from an external server via wireless communication.

The memory 150 may include at least one type of storage medium among a flash memory type, a hard disk type, an SSD type, an SDD type, a multimedia card micro type, a card type memory (e.g., an SD or XD memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. In addition, the memory may be a database that is separate from the device but connected by wire or wirelessly.

The communication module 160 may include one or more components that enable communication with an external device, and may include, for example, at least one of a broadcast reception module, a wired communication module, a wireless communication module, a short-range communication module, or a location information module.

Although not illustrated, the entry management server 100 of the present disclosure may further include an output module and an input module.

The output module may display a user interface (UI) for providing an entry management procedure and result to the service server. The output module may output any form of information generated or determined by the processor 110 and any form of information received by the communication module 160.

The output module may include at least one of a liquid crystal display (LCD), a thin film transistor-liquid crystal display (TFT LCD), an organic light-emitting diode (OLED), a flexible display, and a three-dimensional display (3D display). Some of these display modules may be configured as transparent or light-transmitting so that the outside may be seen through them. This may be referred to as a transparent display module, and a representative example of the transparent display module is TOLED (Transparent OLED).

The input module may receive information input by a user. The input module may have keys and/or buttons on the user interface, or physical keys and/or buttons, for receiving information input by a user. A computer program for controlling a display according to embodiments of the present disclosure may be executed according to user input through the input module.

FIG. 3 is a flowchart for describing an entry management method of the present disclosure.

Hereinafter, a part of FIG. 3 will be described with reference to FIG. 4, which is a flowchart for describing in detail.

The processor 110 of the entry management server 100 may collect the status information through the TS processing module 120 or the IC processing module 130 (step 1100). The status information may be service status information or service server information collected from the service server 300.

For example, the processor 110 may collect the service status information from a button or page linked to the entry management function through the TS processing module 120. This may be obtained from the entry management server 100 itself by receiving an entry request from the user terminal 200.

Specifically, the processor 110 may collect the service status information including at least one of a processing speed, a service request volume, a number of waiting users, a waiting time, a system entry volume, a resource usage, or a processing time, including user-perceived speed and response speed in a transaction linked to the entry management function through the TS processing module 120.

As another example, the processor 110 may collect the service server information including at least one of CPU information, memory information, disk information, network information, a processing volume, a number of threads, a response time, concurrent terminal users, active services, active users, an error rate, a rejection rate, a number of hits per hour, a number of visitors per hour, a number of hits per day, a number of visitors per day, a customer WAS status, JDBC (java database connectivity) idle, JDBC allocation, JDBC activity, total JVM (java virtual machine) memory, or JVM memory usage from the service server 300 through the IC processing module 130.

Next, the processor 110 may set the entry allowance number to the service server 300 based on the status information, but may set an initial entry allowance number or change a preset entry allowance number (step 1200).

Specifically, the processor 110 may compare the status information with a preset entry allowance criterion. Depending on the comparison result, the processor 110 may set the entry allowance number.

For example, the processor 110 may set the entry allowance number through the TS processing module 120.

The processor 110 may control the service status information collected through the TS processing module 120 to be applied to a rule set arbitrarily customized by the operator, and increase or decrease the entry allowance number accordingly when the condition of being above (or below) the threshold is satisfied. That is, the preset entry allowance criterion described above may include a range including a specific upper limit and lower limit, and when the status information matches this, the preset entry allowance number may be maintained. In the case that the entry allowance number is initially set, the preset initial value may be set as the initial entry allowance number.

Specifically, in the case that the service status information matches the preset entry allowance criterion, the processor 110 may set the initial entry allowance number through the TS processing module 120, or maintain the preset entry allowance number.

In the case that the service status information does not match the preset entry allowance criterion, the processor 110 may set the initial entry allowance number, or increase or decrease the preset entry allowance number, based on the comparison result through the TS processing module 120. At this time, when setting the initial entry allowance number, considering the case where the service status information does not match the preset entry allowance criterion, the preset initial value may be increased or decreased based on the comparison result to set the initial entry allowance number.

As another example, the processor 110 may set the entry allowance number through the IC processing module 130. The processor 110 may be equipped with the IC processing module 130 for automatic control of a separate entry allowance number, so that the entry allowance number may be automatically controlled.

The processor 110 may check the current real-time server status of the WAS based on the service server information collected from the APM through the IC processing module 130 and automatically increase or decrease the entry allowance number. In the case that the IC processing module 130 and the entry management server 100 are implemented separately, the IC processing module 130 may transmit an entry allowance number increase or decrease command to the entry management server 100.

For example, in the case that one of the three WASs of the customer company has a problem and is down, the processor 110 may adjust the entry allowance number to be lower than the current status to ensure smooth operation of the service server 300.

The algorithm that automatically increases and decreases the above-described entry allowance number according to a preset rule based on the collected service server information may be customized according to the operator's needs. At this time, the data collected as the service server information may also be customized by the operator. For example, the items of the service server information collected may also be adjusted depending on whether it is based on the CPU or the response time.

In the case that the service server information matches the preset entry allowance criterion, the processor 110 may set the initial entry allowance number through the IC processing module 130 or maintain the preset entry allowance number.

In the case that the service server information does not match the preset entry allowance criterion, the processor 110 may set the initial entry allowance number or increase or decrease the preset entry allowance number according to the comparison result through the IC processing module 130.

As another example, the processor 110 may set the entry allowance number through the TS processing module 120 and the IC processing module 130.

In the case that only the service status information described above is used, the value of information included in the service status information may be relatively low depending on the communication environment of the user terminal 200, and such service status information may be collected. The service status information collected in this way may differ from the actual situation due to the influence of the environment in which the user terminal 200 is connected to the communication. For example, in the case that the user terminal 200 is a mobile terminal in an environment where communication is not smooth compared to a wired terminal PC, the response time may be delayed.

In the case described above, the service server information, which is backend data such as APM data, is normal, but may be classified as abnormal due to the service status information, and thus unnecessary entry allowance number reduction may be performed.

Accordingly, this embodiment sequentially utilizes both the service status information and the service server information described above, so that the entry allowance number may be increased or decreased through mutual supplementation.

Since this disclosure is based on a cloud service such as SaaS, it is expected that the service server information, which is the customer's backend data collected by the IC processing module 130, may be additionally considered.

Referring to FIG. 4, the processor 110 may compare the service status information with the preset entry allowance criterion at the step of setting the entry allowance number through the TS processing module 120 (step 2100).

In the case that the comparison result of step 2100 shows that the service status information does not match the preset entry allowance criterion, the processor 110 may compare the service server information with the preset entry allowance criterion through the IC processing module 130 (steps 2200 and 2300).

In the case that the comparison result of step 2300 shows that the service server information does not match the preset entry allowance criterion, the processor 110 may change the entry allowance number by increasing or decreasing it according to the comparison result through the IC processing module 130 (steps 2400 and 2500).

In the case that the comparison result of 2100 shows that the service status information matches the preset entry allowance criterion, the processor 110 may set the preset initial entry allowance number to the entry allowance number through the TS processing module 120, or maintain the previous initial entry allowance number (step 2600).

In the case that the comparison result of 2300 shows that the service server information matches the preset entry allowance criterion, the processor 110 may set the preset initial entry allowance number to the entry allowance number through the IC processing module 130, or maintain the previous initial entry allowance number (step 2600).

In the above-described steps 2100 to 2600, the procedure is performed to first check whether the service status information matches the entry allowance criterion based on the service status information, but the present invention is not limited thereto, and it may also be possible to perform a procedure that compares the entry allowance criterion preferentially.

Next, the processor 110 may verify and readjust the entry allowance number through the verification module 140.

For example, the processor 110 may verify whether there is history of the same event of the service server 300 through the verification module 140.

As a result of the verification, in the case that the history of the same event of the service server is not present, the processor 110 may learn and store a first artificial intelligence model with the entry allowance number that is to be verified through the verification module 140 as an initial case, or may omit the verification procedure for the entry allowance number.

As a result of the verification, in the case that the history of the same event of the service server is present, the processor 110 may determine whether the entry allowance number is required to be adjusted by applying the first artificial intelligence model learned based on the history for the same event of the service server 300 through the verification module 140. That is, the processor 110 verifies the entry allowance number set based on the first artificial intelligence model through the verification module 140.

As a result of the determination, in the case that the entry allowance number is required to be adjusted, the processor 110 may change the entry allowance number and recommend it according to the determination result through the verification module 140, or may directly change the entry allowance number.

The history may include past measurement data, past entry allowance number, and past occurrence event of the service server 300.

Specifically, the processor 110 may verify whether it is appropriate to apply the entry allowance number set by the IC processing module 130 through the verification module 140.

The processor 110 may recommend and change the entry allowance number based on the first artificial intelligence model learned based on the history of the same event performed by the service server 300 collected by the IC processing module 130 through the verification module 140.

For example, in the case that the entry management function is linked to the course registration button of the course registration site, the processor 110 recommends and changes the appropriate entry allowance number for the course registration in the second semester based on the environment at the time of the course registration in the first semester and the history of abnormal occurrences of the service server 300 through the verification module 140.

Hereinafter, the learning method of the first artificial intelligence model described above will be described.

First, the processor 110 may set a threshold value according to the operator's arbitrary setting through the verification module 140.

The processor 110 may calculate a relationship between the measurement data including the service status information and the service server information and the entry allowance number based on the history of the same service server 300 through the verification module 140. In this case, the relationship may be identified based on the measurement data measured in the past on the same service server 300, the entry allowance number controlled at that time, and the event situation that occurred.

For example, the relationship may include a special event such as a server down or excessive traffic occurrence when the past CPU usage is a specific usage and the CPU average processing amount is a specific processing amount.

The above-described measurement data may mean the status data of the service server 300 that changes in real time. For example, the measurement data may include the increase or decrease in user traffic, the expected time of an event occurrence, the expected number of users connected when the event occurs, and the number of users allowed to be allocated to the event (e.g., 5,000 draw targets). In this case, the draw may mean that only winners may purchase a specific product (e.g., limited edition shoes or newly released shoes).

In addition, the occurrence event may include server downtime, excessive traffic, page load error, excessive processing time, and the like

When the processor 110 learns the first artificial intelligence model through the verification module 140, the method of applying the data of the above-described history may be arbitrarily set by the operator. For example, the average, median, and middle values for each quarter for two years may be applied.

The processor 110 may teach the first artificial intelligence model the appropriate entry allowance number threshold set based on the history through the verification module 140.

As another example, the processor 110 may additionally consider the load test result of the service server 300 through the verification module 140.

Specifically, the processor 110 may perform a load test in advance on the service server 300 that uses the entry management service through the verification module 140 and receive the result in return. For example, the WAS on the service server 300 side determines how many operations may be processed per second and returns the result to the processor 110. At this time, the operation of the WAS may mean processing an application service for a request message transmitted from the WEB.

The processor 110 may set a second entry allowance number based on the result of the load test returned from the WAS through the verification module 140. At this time, the second entry allowance number may include the initial entry allowance number or the entry allowance number to be changed.

The processor 110 may compare the first entry allowance number generated through the TS processing module 120 or IC processing module 130 described above with the second entry allowance number through the verification module 140, and may maintain or change the first entry allowance number according to the comparison result. At this time, when comparing the first entry allowance number and the second entry allowance number, in the case that the difference between them is within the error range by applying an error range, the first entry allowance number may be maintained, and in the case that the difference exceeds the error range, the second entry allowance number may be changed to the second entry allowance number.

As another example, the processor 110 may determine whether the entry allowance number needs to be adjusted by applying a second artificial intelligence model learned based on the history of the same event of another service server similar to the service server 300 through the verification module 140.

That is, the processor 110 may consider a technology for determining whether the APM measurement data collected from another service server similar to the service server 300 and the appropriateness of the increase and decrease case of the entry allowance number through the verification module 140.

First, the processor 110 may classify the similar other service servers based on a structural similarity factor of the service server through the verification module 140. Specifically, the processor 110 may classify and database other service servers that are similar to the target service server 300 in terms of architecture, a WAS number, a CPU, an entry management function application structure (e.g., arrangement and number of buttons to which the entry management function is applied) through the verification module 140.

At this time, even in the case that the service server 300 and other service servers are the same course registration site, the server structure may be completely different depending on the user application design, so when classifying similar other service servers, rather than classifying them according to the purpose of the site and server, the similarity may be determined by considering all factors such as a server architecture, a WAS, and CPU specifications.

Thereafter, the processor 110 may call a list of similar other service servers to determine whether the increase or decrease in the entry allowance number in the target service server 300 is appropriate when determining appropriateness through the verification module 140. At this time, the processor 110 may extract the similarity of other service servers based on the comparison of the structural similarity factor through the verification module 140.

Next, the processor 110 may classify other service servers based on the status similarity factor of the service server through the verification module 140.

The processor 110 may calculate the status similarity of other service servers by using factors such as the increase and decrease trend of user traffic within the service server 300, the number of concurrently connected users and users waiting in the entry management server 100 when an event (e.g., first-come-first-served draw, course registration, etc.) occurs, and the number of users using the entry management server 100 in a normal time (Monthly Active User) without an event as factors, and may consider this in determining the appropriateness of the increase/decrease in the entry allowance number.

The processor 110 may calculate the final similarity by mixing each similarity factor at a preset ratio based on the structural similarity and state similarity described above through the verification module 140. In this case, it is natural that other criteria of similarity are added according to the operator's needs in addition to the applied structural similarity and state similarity.

The above-described ratio may be arbitrarily set according to the operator's needs, such as the operator's management purpose of the service server 300, the type of event that requires entry allowance control, and the like.

The processor 110 may calculate the service status information or the service server through the verification module 140. When determining whether the entry allowance number set through information is appropriate, the relationship between the measurement data of other service servers classified as similar to a threshold or higher based on the similarity judgment factors described above and the entry allowance number may be calculated. At this time, the threshold may be arbitrarily set by the operator.

At this time, the relationship may be identified based on the measurement data measured in the past from other service servers classified as similar to a threshold or higher, the entry allowance number controlled at that time, and the event situation that occurred. For example, the relationship may include special events such as server downtime, excessive traffic occurrence, and the like that occurred when the past average CPU usage is a specific usage and the average CPUI processing amount is a specific processing amount in five similar other service servers.

Meanwhile, the processor 110 may check the history of other service servers with a similarity level set to a higher number. Referring to FIG. 5, in the case that the service server 300 of the present disclosure is a server of University A, which provides various events to students, such as course registration, exchange student application, and scholarship application, the processor 110 may collect the past service server information of University B, University C, and University D, which are similar to University A. Based on the result of determining the similarity between University B, University C, and University D and University A (University B—95%, University C—91%, and University D—80%), the processor 110 may set the top few percent or top few universities as similar other service servers, and perform verification on the entry allowance number calculated based on this.

In this case, when determining the similarity of other service servers through the verification module 140, the processor 110 may make the determination based on the history (i.e., past service server information) of other service servers corresponding to the event to which the entry allowance number to be verified is applied.

For example, in the case that the entry allowance number to be verified is a course registration event button or page of a university, the processor 110 may extract and determine information related to the course registration event from the past service server information collected from the service servers of University B, University C, and University D. In other words, even for one university service server, the similarity may be calculated differently depending on the event to which the entry allowance number to be verified is applied.

After the classification of the similar other service servers described above, the method of learning the second artificial intelligence model based on the information of the similar other service servers is the same as the method of learning the first artificial intelligence model described above, except that it is based on the information of the similar other service servers, and thus a detailed description thereof will be omitted.

Next, the processor 110 may control the entry of the user terminal 200 into the service server 300 based on the set entry allowance number. Although not shown in FIG. 2, the processor 110 may control the key issuance and key retrieval to the user terminal 200 that requested entry based on the entry allowance number through the TS processing module 120.

Meanwhile, the method according to the present disclosure described above may be implemented as a program (or application) to be executed by being combined with a hardware server and stored in a medium.

The disclosed embodiments may be implemented in the form of a recording medium that stores instructions executable by a computer. The instructions may be stored in the form of program codes, and when executed by a processor, may generate a program module to perform the operations of the disclosed embodiments. The recording medium may be implemented as a computer-readable recording medium.

The computer-readable recording medium includes all types of recording media that store instructions that may be deciphered by a computer. For example, there may be ROM (Read Only Memory), RAM (Random Access Memory), magnetic tape, magnetic disk, flash memory, optical data storage, and the like

The disclosed embodiments have been described with reference to the attached drawings as described above. Those skilled in the art to which the present disclosure pertains will understand that the present disclosure may be implemented in forms other than the disclosed embodiments without changing the technical idea or essential features of the present disclosure. The disclosed embodiments are exemplary and should not be construed as limiting.

1. An entry management server of a service server based on a digital service, comprising:
a TS processing module;
an IC processing module; and
a processor,
wherein the processor is configured to:
collect status information through the TS processing module and receive a load test result for the service server,
set an entry allowance number to the service server based on the status information and the load test result through the IC processing module, and control an entry of a user terminal to the service server based on the entry allowance number,
before controlling the entry to the service server, based on history of a same event of the service server being not present when the entry allowance number is verified and then readjusted, the entry allowance number is used as an initial case and trained with a first AI model,
based on history being present, determine whether the entry allowance number is required to be adjusted through a second AI model trained with the history, wherein the history includes past measurement data of the service server, a past entry allowance number, and a past occurrence event, and
when controlling the entry to the service server, retrieve an issued key as soon as the entry to the service server is completed through the TS processing module by the user in a queue, and issue the key to another user in the queue.

2. The server according to claim 1, wherein the processor is configured to:
when setting the entry allowance number, compare the status information with a preset entry allowance criterion, and
set the entry allowance number according to the comparison result.

3. The server according to claim 2,
wherein the status information includes service status information including at least one of a processing speed including a user perceived speed and a response speed, a service request volume, a waiting user number, a waiting time, a system entry volume, a resource usage, or a processing time, and
wherein the processor is configured to: when setting the entry allowance number, based on the service status information matching the preset entry allowance criterion, set an initial entry allowance number or maintain the entry allowance number.

4. The server according to claim 3, wherein the processor is configured to:
when setting the entry allowance number, based on the service status information not matching the preset entry allowance criterion, set the initial entry allowance number, or increase or decrease the entry allowance number, based on the comparison result.

5. The server according to claim 2,
wherein the status information includes service server information including at least one of CPU information, memory information, disk information, network information, processing capacity, a number of threads, a response time, concurrent terminal users, an active service, an active user, an error rate, a rejection rate, a number of hits per hour, a number of visitors per hour, a number of hits per day, a number of visitors per day, a customer WAS status, JDBC (java database connectivity) idle, JDBC allocation, JDBC activity, total JVM (java virtual machine) memory, or JVM memory usage, and
wherein the processor is configured to:
when setting the entry allowance number, based on the service server information matching the preset entry allowance criterion, set an initial entry allowance number or maintain the entry allowance number, and
when setting the entry allowance number, based on the service server information not matching the preset entry allowance criterion, set the initial entry allowance number, or increase or decrease the entry allowance number, based on the comparison result.

6. The server according to claim 1, wherein the processor is configured to:
when setting the entry allowance number, compare the service status information with a preset entry allowance criterion,
based on the service status information not matching the preset entry allowance criterion as a result of the comparison, compare the service server information with the preset entry allowance criterion, and
based on the service status information not matching the preset entry allowance criterion as a result of the comparison, increase or decrease the entry allowance number according to the comparison result.

7. The server according to claim 1, wherein the processor is configured to:
based on the entry allowance number being required to be adjusted, change and recommend the entry allowance number according to the determination result, or directly change the entry allowance number.

8. An entry management method of a service server based on a digital service performed by an entry management server, comprising:
collecting status information and receiving a load test result for the service server;
setting an entry allowance number to the service server based on the status information and the load test result; and
controlling an entry of a user terminal to the service server based on the entry allowance number,
wherein the entry management server is configured to:
before controlling the entry to the service server, based on history of a same event of the service server being not present when the entry allowance number is verified and then readjusted, the entry allowance number is used as an initial case and trained with a first AI model,
based on history being present, determine whether the entry allowance number is required to be adjusted through a second AI model trained with the history, wherein the history includes past measurement data of the service server, a past entry allowance number, and a past occurrence event, and
when controlling the entry to the service server, retrieve an issued key as soon as the entry to the service server is completed through the TS processing module by the user in a queue, and issue the key to another user in the queue.

9. The method according to claim 8, wherein the entry management server is configured to:
when setting the entry allowance number, compare the status information with a preset entry allowance criterion, and
set the entry allowance number according to the comparison result.

10. The method according to claim 9,
wherein the status information includes service status information including at least one of a processing speed including a user perceived speed and a response speed, a service request volume, a waiting user number, a waiting time, a system entry volume, a resource usage, or a processing time, and
wherein the entry management server is configured to: when setting the entry allowance number, based on the service status information matching the preset entry allowance criterion, set an initial entry allowance number or maintain the entry allowance number.

11. The method according to claim 10, wherein the entry management server is configured to:
when setting the entry allowance number, based on the service status information not matching the preset entry allowance criterion, set the initial entry allowance number, or increase or decrease the entry allowance number, based on the comparison result.

12. The method according to claim 9,
wherein the status information includes service server information including at least one of CPU information, memory information, disk information, network information, processing capacity, a number of threads, a response time, concurrent terminal users, an active service, an active user, an error rate, a rejection rate, a number of hits per hour, a number of visitors per hour, a number of hits per day, a number of visitors per day, a customer WAS status, JDBC (java database connectivity) idle, JDBC allocation, JDBC activity, total JVM (java virtual machine) memory, or JVM memory usage, and
wherein the entry management server is configured to:
when setting the entry allowance number, based on the service server information matching the preset entry allowance criterion, set an initial entry allowance number or maintain the entry allowance number, and
when setting the entry allowance number, based on the service server information not matching the preset entry allowance criterion, set the initial entry allowance number, or increase or decrease the entry allowance number, based on the comparison result.

13. The method according to claim 8, wherein the entry management server is configured to:
when setting the entry allowance number, compare the service status information with a preset entry allowance criterion,
based on the service status information not matching the preset entry allowance criterion as a result of the comparison, compare the service server information with the preset entry allowance criterion, and
based on the service status information not matching the preset entry allowance criterion as a result of the comparison, increase or decrease the entry allowance number according to the comparison result.

14. The method according to claim 8, wherein the entry management server is configured to:
based on the entry allowance number being required to be adjusted, change and recommend the entry allowance number according to the determination result, or directly change the entry allowance number.
